(19) United States
(12) Patent Application Publication
(10) Pub. No.: US 2018/0144007 A1
(43) Pub. Date: May 24, 2018

(54) CONTROL SERVER

(71) Applicants: Kabushiki Kaisha Toshiba, Tokyo (JP); Toshiba Infrastructure Systems & Solutions Corporation, Kawasaki-shi (JP)

(72) Inventor: Genki TATENO, Hino, Tokyo (JP)

(21) Appl. No.: 15/784,442

(22) Filed: Oct. 16, 2017

(30) Foreign Application Priority Data
Nov. 24, 2016 (JP) 2016-228263

(51) Int. Cl. G06F 17/30; G06F 9/44; G06F 9/46

(52) U.S. Cl. CPC G06F 17/30318; G06F 17/30418; G06F 9/465; G06F 9/4428; G06F 17/30607

(57) ABSTRACT

According to one embodiment, a control server includes a storage that stores an object program, a know-how database and a weight database, and a processor. The processor determines a processing result of a first processing executed by the object having received an execution instruction is effective when a sum is equal to or larger than a certain threshold, the sum being a sum of weights for an identified client apparatus out of weights associated with an object ID of the object having received the execution instruction in the weight database.

### CROSS-REFERENCE TO RELATED APPLICATIONS

This application is based upon and claims the benefit of priority from Japanese Patent Application No. 2016-228263, filed on Nov. 24, 2016; the entire contents of which are incorporated herein by reference.

### FIELD

Embodiments described herein relate generally to a control server.

### BACKGROUND

Attention is drawn to cloud services (hereinafter, described as clouds) that use computer resources via global networks (particularly, the Internet) exceeding local area networks (LANs). An increase in speed of networks and an increase in capacity of memories and media help the clouds to attract attention. Users can execute various types of computing processing and store data using computer resources (what are called global resources) coupled via the global network without depending on local computer resources via which the users originally need to execute the various types of computing processing and to store data.

An example of such clouds is a control cloud applied to an industrial control system. Conventional industrial control systems control control target instruments such as valves and sensors in local control systems using objects (e.g., computer resources, hereinafter described as services, such as program organization units (POUs), variables, and tasks) provided by controllers in the local control systems. The control cloud controls the control target instruments using services provided by a control cloud server in the control cloud.

The control cloud server provides services to the local control system using data (hereinafter described as raw data) transmitted from client apparatuses included in the local control system. The client apparatuses have different aims in receiving services. For example, one of the client apparatuses, which is used by a plant owner and an operator, utilizes the services provided by the control cloud server for failure diagnosis, failure prevention, failure preventive maintenance, and production management of control target instruments. Another one of the client apparatuses mainly utilizes the POUs and variables out of the services provided from the control cloud server.

When providing its owning service in relation to failure diagnosis to the local control system, the control cloud server needs to provide the service after determining whether raw data is effective for the failure diagnosis, for example. The users who operate respective client apparatuses in the local control system have different understandings and different knowledge on control results of the control target instruments depending on the user's roles. As a result, raw data determined to be effective differs from user to user. It is, thus, difficult for the control cloud server to collect raw data provided by the client apparatuses operated by the users having different roles and provide the services.

### BRIEF DESCRIPTION OF THE DRAWINGS

FIG. 1 is a schematic diagram illustrating an exemplary structure of a control system according to a first embodiment;

FIG. 2 is a schematic diagram illustrating exemplary structures of a control cloud server and a local control system that are included in the control system in the first embodiment;

FIG. 3 is a schematic diagram illustrating an exemplary functional structure of the control cloud server included in the control system in the first embodiment;

FIG. 4 is a schematic diagram illustrating an exemplary data structure of an object database included in the control cloud server in the first embodiment;

FIG. 5 is a schematic diagram illustrating an exemplary data structure of a know-how database included in the control cloud server in the first embodiment;

FIG. 6 is a schematic diagram illustrating an exemplary data structure of a weight database included in the control cloud server in the first embodiment;

FIG. 7 is a flowchart illustrating change processing of the databases performed by the control cloud server according to a second embodiment;

FIG. 8 is a schematic diagram illustrating an exemplary structure of a control system according to a third embodiment;

FIG. 9 is a schematic diagram illustrating examples of the object databases stored in the respective control cloud servers included in the control system in the third embodiment;

FIG. 10 is a schematic diagram illustrating an example of a client database included in the control cloud server according to a fourth embodiment;

FIG. 11 is a schematic diagram illustrating an example of a reference database included in the control cloud server in the fourth embodiment; and

FIG. 12 is a flowchart illustrating the change processing of the databases performed by the control cloud server in the fourth embodiment.

### DETAILED DESCRIPTION

Control servers according to embodiments each include a storage that stores an object program, a know-how database and a weight database, and a processor. When receiving an execution instruction from a client apparatus, the object program executes first processing for determining whether data is effective in accordance with a condition expression set to each client apparatus, the data being received from the client apparatus and regarding a control target instrument included in an external system. The know-how database stores therein, for each client apparatus, the condition expression in association with an object ID capable of identifying the object, the condition expression being used for executing the first processing on the data received from the client apparatus. The weight database stores therein, for each client apparatus, weights in association with the object ID, the weight being added to the data that have been determined to be effective by the first processing. The processor executes the object program, identifies, in the know-how database, the client apparatus the data of which has been determined to be effective in accordance with the condition expression associated with the object ID of the object having received the execution instruction, and determines that the processing result of the first processing executed by the client apparatus having received the execution instruction is effective when a sum is equal to or larger than a certain threshold, the sum being a sum of weights for the data received from the identified client apparatus out of the weights associated with the object ID of the object having received the execution instruction in the weight database.

The following describes control systems to which the control servers in respective embodiments are applied with reference to the accompanying drawings.

### First Embodiment

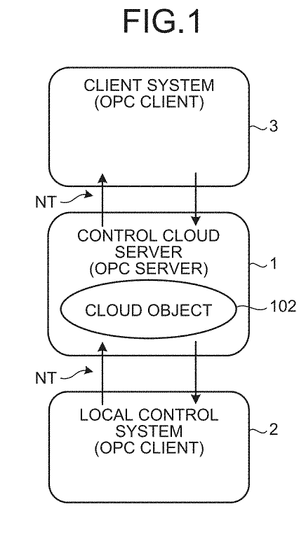

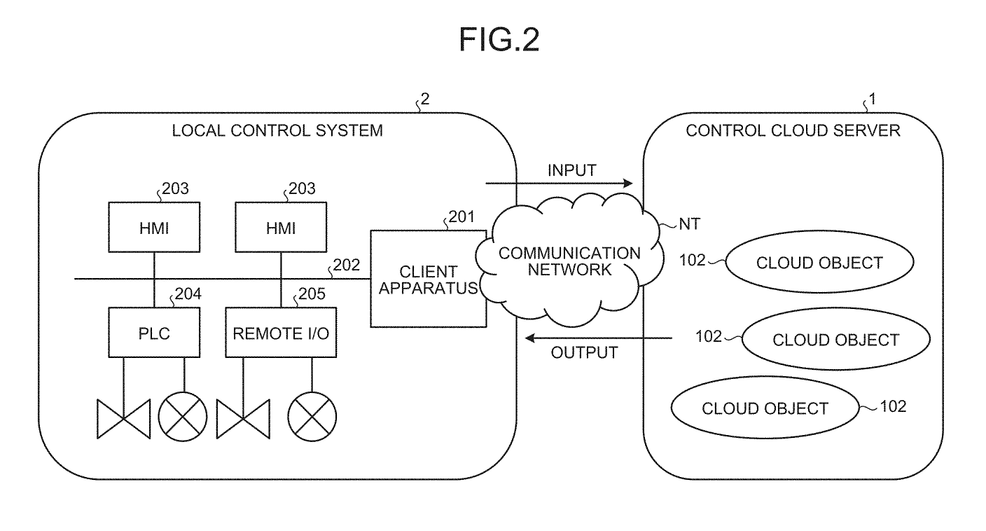

FIG. 1 is a schematic diagram illustrating an exemplary structure of a control system according to a first embodiment. As illustrated in FIG. 1, the control system in the first embodiment includes a control cloud server 1 (an example of the control server), a local control system 2 (an example of the external system), and a client system 3. The local control system 2 is managed by a vendor that provides facilities in the system, for example. The local control system 2 includes a controller that controls the plant facilities such as sensors and valves using cloud objects 102, which are described later, client apparatuses 201 (refer to FIG. 2) that transmit raw data about control target instruments such as the plant facilities and the controller to the control cloud server 1. The client system 3, which is managed by a plant owner who manages, operates, and maintains the local control system 2 and operators, for example, includes the client apparatuses 201 (refer to FIG. 2). The control cloud server 1 includes services 102 (hereinafter, described as cloud objects). Examples of the cloud objects 102 include program organization units (POUs), variables, and tasks. In the first embodiment, the cloud object 102 includes raw data received from the client apparatus 201. Furthermore, the cloud object 102 includes an object that executes processing (hereinafter described as the determination processing, which is the example of the first processing) that determines whether raw data received from the client apparatus 201 is effective in accordance with a condition expression set for each client apparatus 201 (refer to FIG. 2) when receiving an execution instruction from the client apparatus 201.

In the first embodiment, the control cloud server 1, the local control system 2, and the client system 3 are coupled with one another via a communications network NT such as a local area network (LAN). Each of the local control system 2 and the client system 3 exchanges various types of data such as raw data with the control cloud server 1 in accordance with object linking and embedding for process control (OLE for process control or OPC), thereby determining a failure state of a central processing unit (CPU) of the controller included in the local control system 2, managing production of products with the control target instruments, or managing facilities included in the local control system 2, using the cloud objects 102.

FIG. 2 is a schematic diagram illustrating exemplary structures of the control cloud server and the local control system that are included in the control system in the first embodiment. As illustrated in FIG. 2, the local control system 2 includes the client apparatuses 201 (what are called OPC clients) each of which functions as a client function unit that serves as an interface with the communication network NT and is capable of communicating with the control cloud server 1 in accordance with the OPC, a plurality of human machine interfaces (HMIs) 203 each of which is connected to a LAN 202 and each of which an operator performs various operations, a programmable logic controller (PLC) 204, which is an example of the controller, connected to the LAN 202, and a plurality of remote I/Os 205 that are connected to the LAN 202 and serve as interfaces with the control target instruments. As illustrated in FIG. 2, the control cloud server 1 includes the cloud objects 102. The client system 3 also includes the client apparatuses 201.

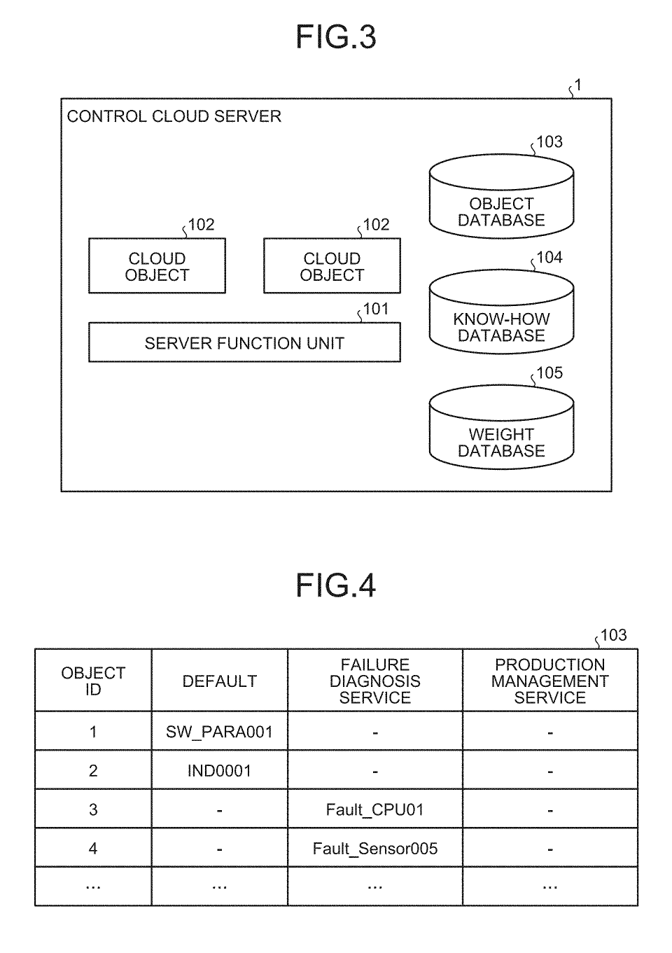

FIG. 3 is a schematic diagram illustrating an exemplary functional structure of the control cloud server included in the control system in the first embodiment. As illustrated in FIG. 3, the control cloud server 1 includes a server function unit 101 (what is called an OPC server), the cloud objects 102, an object database 103, a know-how database 104, and a weight database 105.

The object database 103 stores therein an object ID that can identify the cloud object 102 and the name of the cloud object 102 identified by the object ID in association with each other. The object ID is a number that can identify the cloud object 102 in the control cloud server 1, for example.

FIG. 4 is a schematic diagram illustrating an exemplary data structure of the object database included in the control cloud server in the first embodiment. When the cloud object 102 is raw data, as illustrated in FIG. 4, the object database 103 stores therein the default (e.g., “SW_PARA001”, and “IND0001”), which is the name of the raw data on transmission origins, in association with the object ID of the cloud objects 102. When the cloud object 102 is the POU such as a failure diagnosis service and a production management service, for example, as illustrated in FIG. 4, the object database 103 stores therein the name of the POU (e.g., “Fault_CPU01”, and “Fault_Sensor005”) of the cloud object 102 in association with the object ID of the cloud object 102.

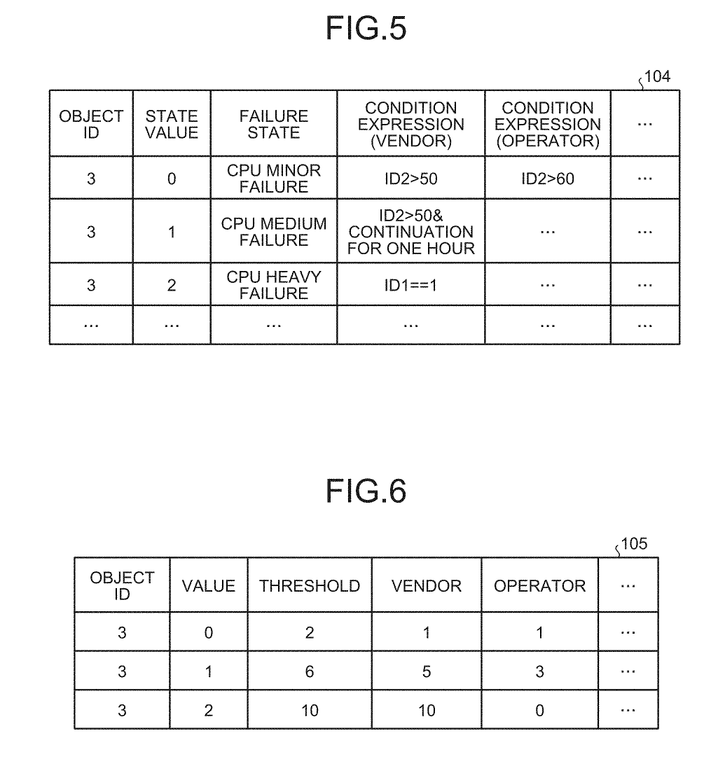

The know-how database 104 stores therein, for each client apparatus 201, the condition expression used for the determination processing on the raw data received from the client apparatus 201 in association with the object ID which is an example of the cloud object 102. FIG. 5 is a schematic diagram illustrating an exemplary data structure of the know-how database included in the control cloud server in the first embodiment. As exemplarily illustrated in FIG. 5, the know-how database 104 stores therein, in association with the object ID of the cloud object 102 executing the determination processing to determine whether the raw data indicating the failure state of the CPU of the PLC 204 (hereinafter, the cloud object 102 is described as the failure diagnosis service), a value (hereinafter, described as a state value) that indicates a failure state indicated by the raw data determined by the failure diagnosis service whether the raw data is effective, a failure state indicated by the raw data, and the condition expressions used for the determination processing executed on the raw data.

In the first embodiment, the failure diagnosis service determines whether the raw data is effective in relation to any of three types of failure states (e.g., a CPU minor failure, a CPU medium failure, and a CPU major failure) of the CPU of the PLC 204 included in the local control system 2. The know-how database 104, thus, stores therein, for each of the three types of CPU failure states determined by the failure diagnosis service, the state value, the failure state, and the condition expressions in association with the object ID of the failure diagnosis service. The CPU minor failure is the lightest failure state out of the three types of failure states of the CPU of the PLC 204 included in the local control system 2, for example. The CPU medium failure is a failure state more serious than the CPU minor failure out of the three types of failure states of the CPU of the PLC 204 included in the local control system 2, for example. The CPU major failure is the most serious failure state out of the three types of failure states of the CPU of the PLC 204 included in the local control system 2, for example.

The weight database 105 stores therein, for each client apparatus 201, weights that are added to the raw data determined to be effective by the cloud object 102 in association with the object ID. FIG. 6 is a schematic diagram illustrating an exemplary data structure of the weight database included in the control cloud server in the first embodiment. As illustrated in FIG. 6, the weight database 105 stores therein the state value, a certain threshold determining that a failure state indicated by the state value is effective, and weights added to the raw data determined to be effective by the failure diagnosis service in association with the object ID of the failure diagnosis service.

The server function unit 101 (what is called an OPC server) functions as a server function unit that serves as an interface with the communication network NT and can communicate with the local control system 2 and the client system 3 in accordance with the OPC. The server function unit 101 reads, from the object database 103, the object ID of the cloud object 102 (hereinafter, described as an execution target object) that receives the execution instruction from the client apparatus 201. The server function unit 101 (an example of the determination unit) then identifies, in the know-how database 104, the client apparatus 201 the raw data of which has been determined to be effective in accordance with the condition expression associated with read object ID.

For example, when the execution target object is the failure diagnosis service, the server function unit 101 identifies the client apparatus 201 the raw data of which has been determined to be effective in accordance with the condition expression associated with the object ID of the failure diagnosis service. Specifically, when the raw data to be determined by the failure diagnosis service whether the raw data is effective is the raw data about the CPU minor failure, the server function unit 101 identifies, in the know-how database 104, the client apparatus 201 the raw data of which has been determined to be effective in accordance with the condition expressions (“ID 2>50” and “ID 2>60”) associated with the object ID “3” of the failure diagnosis service and the failure state “CPU minor failure”.

The condition expression “ID 2>50” determines that the raw data is effective when the cloud object 102 has an object ID “2” and the raw data about the CPU minor failure is larger than “50”. The condition expression “ID 2>60” determines that the raw data is effective when the cloud object 102 has an object ID “2” and the raw data about the CPU minor failure is larger than “60”.

For another example, when the raw data to be determined by the failure diagnosis service whether the raw data is effective is the raw data about the CPU medium failure, the server function unit 101 identifies, in the know-how database 104, the client apparatus 201 the raw data of which has been determined to be effective in accordance with the condition expressions (“ID 2>50” & continuation for one hour” and so on) associated with the object ID “3” of the failure diagnosis service and the failure state “CPU medium failure”. The condition expression “ID 2>50 & continuation for one hour” determines that the raw data is effective when the cloud object 102 has an object ID “2” and the state where the raw data about the CPU medium failure is larger than “50” is continued for equal to or larger than one hour.

For still another example, when the raw data to be determined by the failure diagnosis service whether the raw data is effective is the raw data about the CPU major failure, the server function unit 101 identifies, in the know-how database 104, the client apparatus 201 the raw data of which has been determined to be effective in accordance with the condition expressions (“ID 1==1” and so on) associated with the object ID “3” of the failure diagnosis service and the failure state “CPU major failure”. The condition expression “ID 1==1” determines that the raw data is effective when the cloud object 102 has an object ID “1” and the raw data about the CPU major failure remains as “1” without any change.

After identifying the client apparatus 201 the raw data of which has been determined to be effective in accordance with the condition expressions, the server function unit 101 calculates the sum of the weights to be added to the identified client apparatus 201 out of the weights associated with the object ID of the execution target object in the weight database 105. When the calculated sum is equal to or larger than a certain threshold, the server function unit 101 determines that the processing result of the determination processing executed by the execution target object is effective. The structure described above, thus, makes it possible for the cloud object 102 to execute the determination processing on the basis of different understandings and different knowledge of the users of the respective client apparatuses 201 due to their roles. This increases accuracy in the determination processing executed by the cloud object 102 and makes it possible for operation using the control target instruments in the local control system 2 to be efficiently performed.

For example, when the object ID of the execution target object is “3”, the server function unit 101 calculates the sum as “2” by adding the weight “1” of the client apparatus 201 used by the vendor to the weight “1” of the client apparatus 201 used by the user, out of the weights associated with the object ID “3” in the weight database 105. The server function unit 101, then, compares the calculated sum (e.g., “2”) with a certain threshold (e.g., “2”) that is associated with the object ID of the execution target object (e.g., “3”) and a state value (e.g., “0”) representing the failure state indicated by the raw data to be determined by the failure diagnosis service whether the data is effective in the weight database 105. When the calculated sum is equal to or larger than the certain threshold, the server function unit 101 determines that the processing result of the determination processing executed by the failure diagnosis service is effective.

The control cloud server 1 in the first embodiment can increase the accuracy in the determination processing executed by the cloud object 102 and enables the operation using the control target instruments in the local control system 2 to be performed efficiently.

### Second Embodiment

A second embodiment is an example where the object ID stored in each of the know-how database and the weight database is changed when the object ID stored in the object database is changed. The following describes differences from the first embodiment.

In the second embodiment, when change such as addition, replacement, or deletion is performed on the object ID stored in the object database 103, the server function unit 101 (an example of the change unit) changes the object ID corresponding to the changed object ID in the know-how database 104 and the weight database 105. When the change is performed on the object database 103, the change is performed on each of the know-how database 104 and the weight database 105 as described above, thereby avoiding inconsistency between the databases. The change of the object ID in the object database 103 causes the change of the corresponding object ID in each of the know-how database 104 and the weight database 105. This allows easy changing in the databases, resulting in man-hours caused by the changing in the respective databases to be reduced.

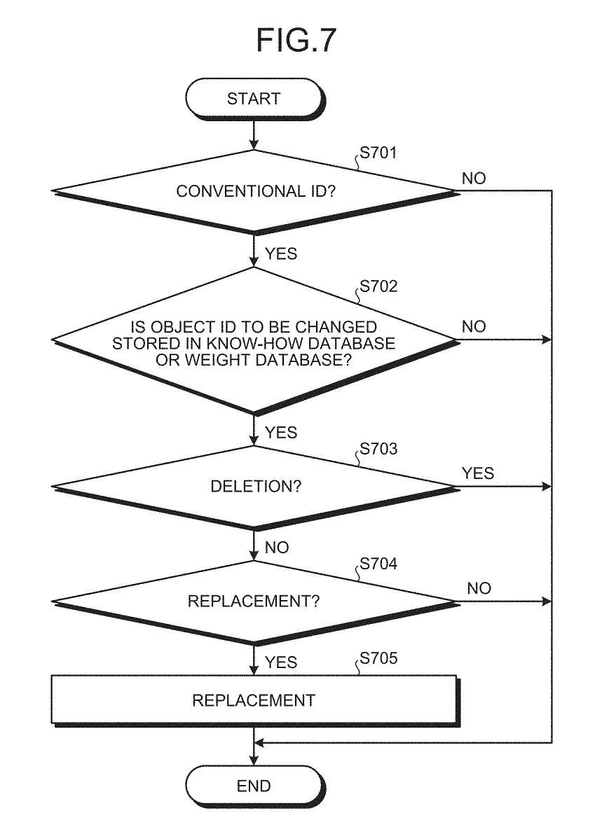

FIG. 7 is a flowchart illustrating the change processing of the databases performed by the control cloud server in the second embodiment. The server function unit 101 changes the object ID stored in the object database 103. when changing the object ID stored in the object database 103, as illustrated in FIG. 7, the server function unit 101 determines whether the object ID to be changed is already stored (hereinafter, the already stored object ID is described as a conventional ID) in the object database 103 (step S701). If the changed object ID is not a conventional ID (No at step S701), that is, the change is an addition of a new object ID, the server function unit 101 ends the change processing of the databases without performing the change on the know-how database 104 and the weight database 105.

If the object ID to be changed is a conventional ID (Yes at step S701), the server function unit 101 determines whether the object ID to be changed is stored in the know-how database 104 or the weight database 105 (step S702). If the changed object ID is not stored in both of the know-how database 104 and the weight database 105 (No at step S702), the server function unit 101 ends the change processing of the databases. If the object ID to be changed is stored in the know-how database 104 or the weight database 105 (Yes at step S702), the server function unit 101 determines whether the change performed on the object ID in the object database 103 is deletion (step S703). If the change performed on the object ID in the object database 103 is deletion (Yes at step S703), the server function unit 101 ends the change processing of the databases.

If the change performed on the object ID in the object database 103 is not deletion (No at step S703), the server function unit 101 determines whether the change performed on the object ID in the object database 103 is replacement of the conventional ID with a new object ID (step S704). If the change performed on the object ID in the object database 103 is not replacement (No at step S704), the server function unit 101 ends the change processing of the databases. If the change performed on the object ID in the object database 103 is replacement (Yes at step S704), the server function unit 101 replaces the conventional ID, which is stored in both of the know-how database 104 and the weight database 105, with the new object ID (step S705).

The control cloud server 1 in the second embodiment can avoid inconsistency between the databases when the change is performed on the object database 103.

### Third Embodiment

A third embodiment is an example where the control cloud server includes the client function unit that is connected to another control cloud server (an example of the external server) receiving raw data from the client apparatuses via an intranet and transmits the determination result indicating whether the processing result of the determination processing executed by the cloud object of the control cloud server is effective to the other control cloud server as raw data. In the following description, the description of the same parts as the first embodiment is omitted.

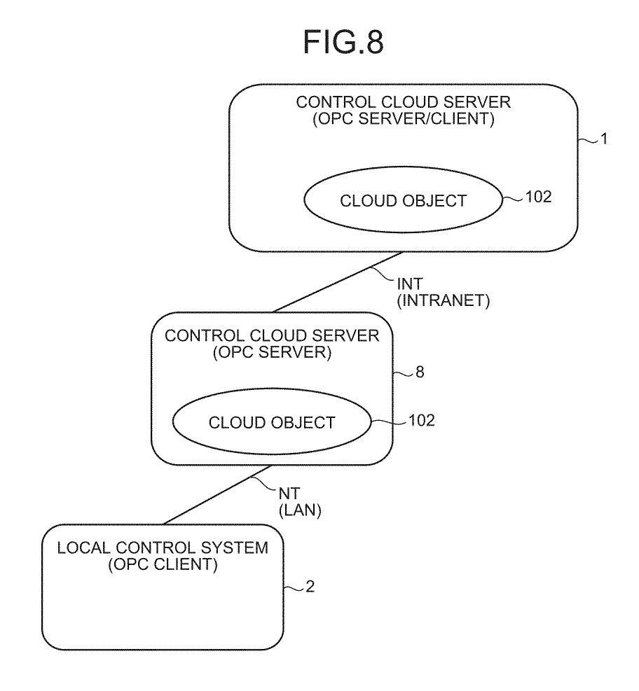

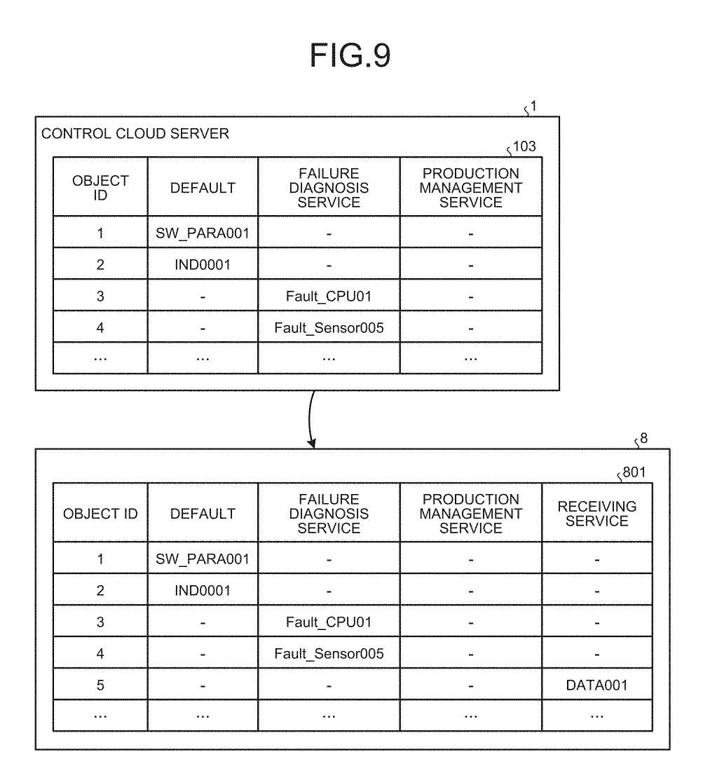

FIG. 8 is a schematic diagram illustrating an exemplary structure of a control system according to the third embodiment. FIG. 9 is a schematic diagram illustrating examples of the object databases stored in the respective control cloud servers included in the control system in the third embodiment. As illustrated in FIG. 8, the control system in the third embodiment includes the control cloud server 1, the local control system 2, and a control cloud server 8 which is another control cloud server. In the third embodiment, the control cloud server 1 is coupled to the control cloud server 8 via an intranet INT. The control cloud server 1 includes the client function unit that causes the control cloud server 1 to function as the client apparatus 201, in addition to the server function unit 101. As illustrated in FIG. 9, the control cloud server 1 includes the object database 103, the know-how database 104, and the weight database 105 in the same manner as the first embodiment. The client function unit transmits the determination result indicating whether the processing result of the determination processing executed by the cloud object 102 included in the control cloud server 1 is effective to the control cloud server 8 as the raw data.

The control cloud server 8 receives the raw data from the client apparatus 201 included in the local control system 2 via the communication network NT. The control cloud server 8 includes a receiving service as the cloud object 102. The receiving service receives the data indicating whether the processing result of the determination processing executed by the cloud object 102 included in the control cloud server 1 is effective from the control cloud server 1 as the raw data via the intranet INT. As illustrated in FIG. 9, an object database 801 included in the control cloud server 8 stores therein the name of the raw data (e.g., DATA001) in the control cloud server 1 in association with the object ID “5” of the cloud object 102 receiving the raw data from the control cloud server 1.

In the control system, the PLC 204 and the communication network NT are required to have high response performance. Upper limits of overheads between the client apparatus 201 and each of the control cloud servers 1 and 8 are assumed to differ from each other depending on the network structures therebetween. In the third embodiment, the client function unit is, thus, included in the control cloud server 1 coupled to the control cloud server 8 via the intranet INT and communicating with the client apparatuses 201. And the client function unit transmits the determination result indicating whether the processing result of the determination processing executed by the cloud object included in the control cloud server 1 to the control cloud server 8 as the raw data.

The control cloud server 1 in the third embodiment causes the control cloud server 8 not to need to determine whether the result of the determination processing executed by the cloud object 102 is effective, thereby making it possible to reduce the overhead in communication between the client apparatus 201 and the control cloud server 8.

### Fourth Embodiment

A fourth embodiment is an example where a reference database is included that stores therein, for each client apparatus, a flag indicating that the cloud object is used by the client apparatus in association with the object ID, and use of the object ID identical to the object ID to which the flag is set in the reference database is prohibited out of the object IDs stored in the object database. In the following description, the description of the same parts as the second embodiment is omitted.

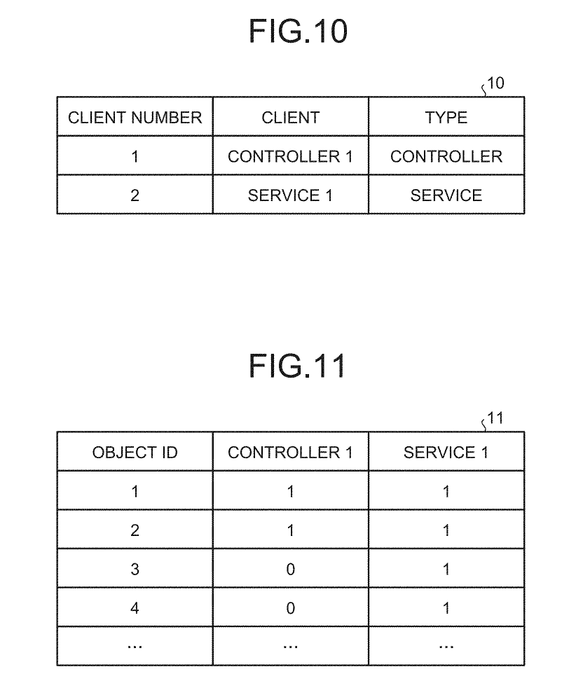

The control cloud server 1 in the fourth embodiment includes a client database 10 and a reference database 11 in addition to the server function unit 101, the cloud objects 102, the object database 103, the know-how database 104, and the weight database 105. FIG. 10 is a schematic diagram illustrating an example of the client database included in the control cloud server in the fourth embodiment. As illustrated in FIG. 10, the client database 10 stores therein the name of the client apparatus 201 and the type of client apparatus 201 in association with a client number that can identify the client apparatus 201.

FIG. 11 is a schematic diagram illustrating an example of the reference database included in the control cloud server in the fourth embodiment. As illustrated in FIG. 11, the reference database 11 stores therein, for each client apparatus 201 stored in the client database 10, the flag indicating whether the client apparatus 201 uses the cloud object 102 identified by the object ID in association with the object ID. A flag of “1” indicates that the client apparatus 201 uses the cloud object 102. A flag of “0” indicates that the client apparatus 201 does not use the cloud object 102.

In the fourth embodiment, the controller such as the PLC 204 included in the local control system 2 outputs a list of the cloud objects 102 used for controlling the control target instruments out of the cloud objects 102 included in the control cloud server 1 to the control cloud server 1 via the client apparatus 201.

The server function unit 101 of the control cloud server 1 acquires the list output from the local control system 2. The server function unit 101 sets the flag to “1” for each object ID of the cloud objects 102 included in the acquired list in the reference database 11. The server function unit 101 prohibits the change of the object ID identical to the object ID to which the flag is set to “1” in the reference database 11 out of the object IDs stored in the object database 103. When the cloud object 102 is used for controlling the control target instruments in the local control system 2, the object ID stored in the object database 103 included in the control cloud server 1 is prevented from being changed. As a result, the control target instruments are prevented from being wrongly operated due to the change of the object ID while the cloud object 102 is used.

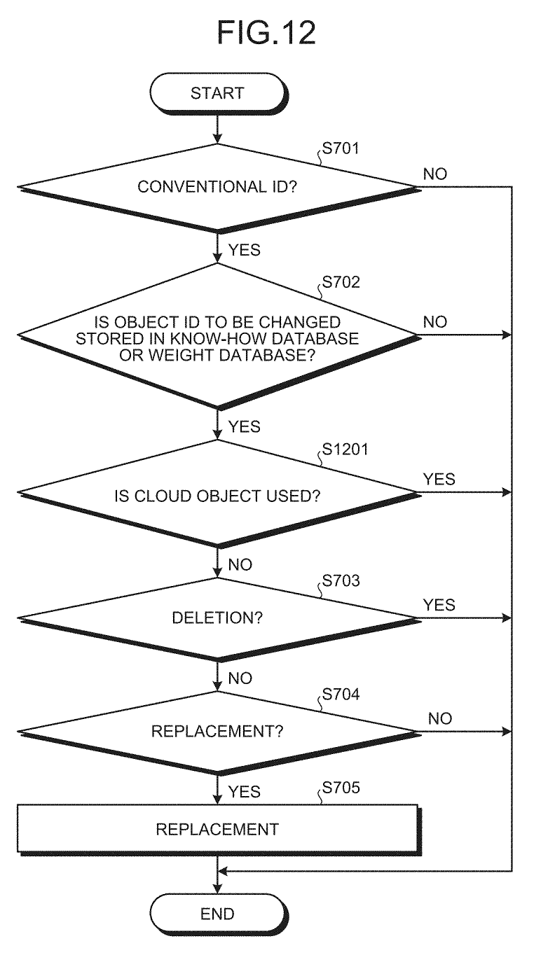

FIG. 12 is a flowchart illustrating the change processing of the databases performed by the control cloud server in the fourth embodiment. If the changed object ID is stored in the know-how database 104 or the weight database 105 (Yes at step S702), the server function unit 101 in the fourth embodiment determines, on the basis of the reference database 11, whether the cloud object 102 identified by the object ID to be changed is used by the controller such as the PLC 204 included in the local control system 2 (step S1201). If the cloud object 102 identified by the object ID to be changed is used by the controller (Yes at step S1201), the server function unit 101 prohibits the change of the object ID each stored in the object database 103, the know-how database 104, and the weight database 105, and then ends the change processing of the databases. If the cloud object 102 identified by the object ID to be changed is not used by the controller (No at step S1201), the server function unit 101 proceeds to the processing at step S703.

The control cloud server 1 in the fourth embodiment can prevent the control target instruments from being wrongly operated due to the change of the object ID while the cloud object 102 is used. As a result, the fourth embodiment can prevent deterioration in safety of a plant including the local control system 2, for example.

A program executed by the control cloud server 1 in each embodiment is embedded and provided in a read only memory (ROM), for example. The program executed by the control cloud server 1 in each embodiment may be recorded and provided on a computer-readable recording medium such as a compact disc read only memory (CD-ROM), a flexible disk (FD), a compact disc recordable (CD-R), and a digital versatile disc (DVD), as an installable or executable file.

The program executed by the control cloud server 1 in each embodiment may be stored in a computer connected to a network such as the Internet and provided by being downloaded via the network. The program executed by the control cloud server 1 in each embodiment may be provided or distributed via a network such as the Internet.

The program executed by the control cloud server 1 in each embodiment has a module structure including the above-described components (the server function unit 101 and the cloud objects 102). In actual hardware, the CPU reads the program from the ROM and executes the program. Once the program is executed, the above-described components are loaded into a main storage, so that the server function unit 101 and the cloud objects 102 are formed in the main storage.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A control server comprising:
a storage that stores an object program, a know-how database and a weight database, wherein
the object program that, when receiving an execution instruction from a client apparatus, executes first processing for determining whether data is effective in accordance with a condition expression set to each client apparatus, the data being received from the client apparatus and regarding a control target instrument included in an external system;
the know-how database storing therein, for each client apparatus, the condition expression in association with an object ID capable of identifying the object, the condition expression being used for executing the first processing on the data received from the client apparatus,
the weight database storing therein, for each client apparatus, a weight in association with the object ID, the weight being added to the data having determined to be effective by the first processing; and
a processor configured to execute the object program, to identify, in the know-how database, the client apparatus the data of which has been determined to be effective in accordance with the condition expression associated with the object ID of the object having received the execution instruction, and to determine a processing result of the first processing executed by the object having received the execution instruction is effective when a sum is equal to or larger than a certain threshold, the sum being a sum of weights for the data received from the identified client apparatus out of the weights associated with the object ID of the object having received the execution instruction in the weight database.

2. The control server according to claim 1, wherein
the storage stores an object database that stores therein a name of the object in association with the object ID; and
the processor changes the object ID included in the know-how database and the weight database, the object ID corresponding to the object ID stored and changed in the object database.

3. The control server according to claim 1, wherein the processor is coupled to an external server via an intranet, the external server receiving the data from the client apparatus, and transmits a determination result indicating whether the processing result of the first processing is effective to the external server as the data.

4. The control server according to claim 2, wherein
the storage stores a reference database that stores therein, for each client apparatus, a flag indicating that the object is used by the client apparatus in association with the object ID,
the processor acquires, from a controller, a list of the objects used by the controller, sets, in the reference database, the flag to the object ID of each object included in the list, and prohibits change of the object ID identical to the object ID to which the flag is set in the reference database out of the object IDs stored in the object database.
